(19) United States
(12) Patent Application Publication
(10) Pub. No.: US 2026/0252155 A1
(43) Pub. Date: Aug. 27, 2026

(54) Electronic system having voltage drop management mechanism and voltage drop management method

(71) Applicant: REALTEK SEMICONDUCTOR COROPORATION, HSINCHU (TW)

(72) Inventors: YI-CHE LEE, HSINCHU (TW); TSUNG-SHENG YU, HSINCHU (TW); KAI-CHEN HUNG, HSINCHU (TW)

(21) Appl. No.: 19/463,550

(22) Filed: Jan. 29, 2026

(30) Foreign Application Priority Data
Feb. 21, 2025 (TW) 114106613

(51) Int. Cl. G06F 1/30; G05F 1/46

(52) U.S. Cl. CPC G06F 1/30; G05F 1/462

(57) ABSTRACT

A voltage drop management method that includes the following steps is provided. One of node voltages of a functional circuit block is detected to drop below a threshold value to generate a voltage drop signal. A voltage drop event is determined to occur and is recorded in a system state. Circuit signals are analyzed according to the system state to select a candidate signal related to the voltage drop event and a signal variation pattern thereof is recorded. A verification process is performed on the signal variation pattern and the occurrence of the voltage drop event to generate prediction reliability. The candidate signal having the prediction reliability within a reliable range is set to be a target signal. A predicted voltage drop signal is generated according to the target signal having the signal variation pattern to drive a power management circuit to perform a voltage stabilizing process on a target circuit.

### BACKGROUND OF THE INVENTION

### 1. Field of the Invention

The present invention relates to an electronic system having a voltage drop management mechanism and a voltage drop management method thereof.

### 2. Description of Related Art

In an electronic system, some circuits, e.g., processors, may separate different function circuits into different power domains to stop to supply power to a domain that is not in operation in order to save power. The power may be supplied to such a domain again when the domain starts to operate. A temporary voltage drop may thus occur. If a precise power drop management mechanism is not presented, the voltage drop may affect the efficiency and accuracy of other circuits that are already operating in the processor.

### SUMMARY OF THE INVENTION

In consideration of the problem of the prior art, an object of the present invention is to supply an electronic apparatus having a voltage drop management mechanism and a voltage drop management method thereof.

The present invention discloses an electronic system having a voltage drop management mechanism that includes a functional circuit block, a power management circuit, a plurality of voltage detectors, a voltage drop analysis circuit and a voltage drop processing circuit. The voltage detectors are configured to detect a plurality of node voltages of the functional circuit block to generate a voltage drop signal to the functional circuit block when any one of the node voltages drops to a threshold value, such that the functional circuit block determines an occurrence of a voltage drop event and document a system state. The voltage drop analysis circuit is configured to perform analysis on a plurality of circuit signals transmitted by the functional circuit block according to the system state, to select one of the circuit signals related to the occurrence of the voltage drop event to be a candidate signal to document a signal variation pattern of the candidate signal corresponding to the voltage drop event and perform a verification process on the signal variation pattern of the candidate signal and the occurrence of the voltage drop event within a period of operation time of the functional circuit block to generate a prediction reliability of the candidate signal corresponding to the voltage drop event. The voltage drop processing circuit is configured to set the candidate signal having the prediction reliability within a reliable range to be a target signal so as to generate a predicted voltage drop signal according to the target signal having the signal variation pattern to drive the power management circuit to generate a power mode control signal to the functional circuit block to perform a voltage stabilizing process on a target circuit related to the target signal in the functional circuit block.

The present invention also discloses a voltage drop management method that includes steps outlined below. A plurality of node voltages of a functional circuit block are detected by a plurality of voltage detectors to generate a voltage drop signal to the functional circuit block when any one of the node voltages drops to a threshold value, such that the functional circuit block determines an occurrence of a voltage drop event and documents a system state. Analysis is performed on a plurality of circuit signals transmitted by the functional circuit block by a voltage drop analysis circuit according to the system state, to select one of the circuit signals related to the occurrence of the voltage drop event to be a candidate signal to document a signal variation pattern of the candidate signal corresponding to the voltage drop event. A verification process is performed on the signal variation pattern of the candidate signal and the occurrence of the voltage drop event within a period of operation time of the functional circuit block by the voltage drop analysis circuit to generate a prediction reliability of the candidate signal corresponding to the voltage drop event. The candidate signal having the prediction reliability within a reliable range is set to be a target signal by a voltage drop processing circuit so as to generate a predicted voltage drop signal according to the target signal having the signal variation pattern to drive a power management circuit to generate a power mode control signal to the functional circuit block to perform a voltage stabilizing process on a target circuit related to the target signal in the functional circuit block.

These and other objectives of the present invention will no doubt become obvious to those of ordinary skill in the art upon reading the following detailed description of the preferred embodiments that are illustrated in the various figures and drawings.

### BRIEF DESCRIPTION OF THE DRAWINGS

FIG. 1 illustrates a block diagram of an electronic system having a voltage drop management mechanism according to an embodiment of the present invention.

FIG. 2 illustrates a flow chart of a voltage drop management method according to an embodiment of the present invention.

### DETAILED DESCRIPTION OF THE PREFERRED EMBODIMENTS

An aspect of the present invention is to provide an electronic system having a voltage drop management mechanism and a voltage drop management method thereof to analyze the system state when the voltage drop event occurs to document a signal variation pattern of a candidate signal so as to set the candidate signal to be a target signal when a prediction reliability associated with the candidate signal is verified to be within a reliable range, such that a predicted voltage drop signal is generated according to the target signal having the signal variation pattern to drive a power management circuit to generate a power mode control signal to perform a voltage stabilizing process on a target circuit that is related to the target signal in a function block to avoid the crash of the circuits due to the voltage drop event.

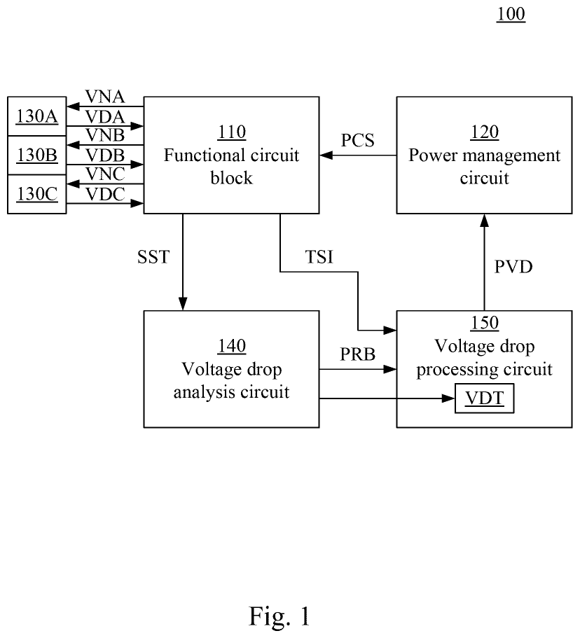

Reference is now made to FIG. 1. FIG. 1 illustrates a block diagram of an electronic system 100 having a voltage drop management mechanism according to an embodiment of the present invention. The electronic system 100 includes a functional circuit block 110, a power management circuit 120, a plurality of voltage detectors 130A~130C, a voltage drop analysis circuit 140 and a voltage drop processing circuit 150.

The functional circuit block 110 may include one or more than one circuits. In an embodiment, the functional circuit block 110 may only include one processing circuit (not illustrated) or may include other functional circuits besides the processing circuit. The one or more than one circuits included by the functional circuit block 110 may further include a plurality of sub-circuits. The operation of functional circuit block 110 described above may be performed by a single circuit that the functional circuit block 110 includes or may be performed together by a plurality of circuits included by the functional circuit block 110. The present invention is not limited to a certain number, a certain configuration or a certain operation of the circuits included in the functional circuit block 110.

In an embodiment, the functional circuit block 110 may include a power circuit (not illustrated) therein to receive an external power and perform processing including such as, but not limited to voltage stabilizing, voltage conversion or a combination thereof to generate a plurality of internal power signals to the circuits and sub-circuits included in the functional circuit block 110.

The power management circuit 120 is configured to generate a power mode control signal PCS to the functional circuit block 110 such that the power circuit in the functional circuit block 110 operates in different power modes according to the power mode control signal PCS.

The voltage detectors 130A~130C is configured to detect a plurality of node voltages VNA~VNC of the functional circuit block 110 to generate at least one of voltage drop signal VDA~VDC to the functional circuit block 110 when any one of the corresponding node voltages VNA~VNC drops to a threshold value, such that the functional circuit block 110 determines an occurrence of a voltage drop event and document a system state SST. In different embodiments, the voltage detectors 130A~130C may transmit the voltage drop signals VDA~VDC to the functional circuit block 110 in the form of interrupts or transmit the voltage drop signals VDA~VDC to the functional circuit block 110 through a dedicated signal transmission path.

In FIG. 1, three voltage detectors 130A~130C are exemplarily illustrated. In fact, based on the configuration and requirements of the functional circuit block 110, e.g., the number of the circuits, the number of the sub-circuits in the circuits and the layout of the circuits and the sub-circuits in the functional circuit block 110, different numbers of the voltage detectors may be included in the functional circuit block 110 to detect the node voltages of the different numbers of the circuit nodes. Moreover, in FIG. 1, the voltage detectors 130A~130C are illustrated outside the functional circuit block 110 in FIG. 1. However, in actual implementation, the voltage detectors 130A~130C can be disposed at the nodes inside the functional circuit block 110 to perform detection.

Take the node voltage VNA as an example, when the voltage detectors 130A detects that the node voltage VNA drops to the predetermined threshold value, the voltage detector 130A generates the voltage drop signal VDA to the functional circuit block 110. For example, the node voltage VNA is 1.2 volts under a normal operation condition, and the threshold value is set to be 1 volt. When the voltage detector 130A detects that the node voltage VNA drops from 1.2 volts to 1 volt, the voltage detector 130A generates the voltage drop signal VDA to the functional circuit block 110.

It is appreciated that the voltage values described above are merely an example. In practical implementation, the node voltages VNA~VNC may have different voltage values and the voltage detectors 130A~130C may configure different threshold values to perform detection. Further, more than one of the voltage detectors 130A~130C may simultaneously detect more than one of the node voltages VNA~VNC drop to the corresponding threshold values and generate more than one voltage drop signals VDA~VDC to the functional circuit block 110.

In an embodiment, the system state SST that the functional circuit block 110 documents may correspond to an occurring time spot of the occurrence of the voltage drop event and/or a time period prior to the occurrence of the voltage drop event. For example, the functional circuit block 110 may document the states of the software and the hardware in the system at the time spot of the occurrence of the voltage drop event and/or a time period prior to the occurrence of the voltage drop event as the system state SST.

The system state SST may include such as, but not limited to a circuit state and/or a process execution state. The circuit state may include the states of the hardware circuit that the functional circuit block 110 includes, such as but not limited to a register state and/or a hardware signal state. The process execution state includes the states of the software and/or the firmware that the processing circuit in the functional circuit block 110 operates, such as but not limited to a process stack and/or a memory data state.

The functional circuit block 110 may store the system state SST in a storage circuit (not illustrated) inside or outside the functional circuit block 110 to be accessed by the voltage drop analysis circuit 140.

The voltage drop analysis circuit 140 is configured to perform analysis on the voltage drops such that the voltage drop processing circuit 150 predicts the occurrence of the voltage drops according to the analysis result and controls the power management circuit 120 to distribute the power provided to the functional circuit block 110 to avoid the occurrence of a crash of the circuit or other issues.

The operation of the voltage drop analysis circuit 140 is described first in the following paragraphs.

The voltage drop analysis circuit 140 performs analysis on a plurality of circuit signals transmitted by the functional circuit block 110 according to the system state SST, to select one of the circuit signals related to the occurrence of the voltage drop event to be a candidate signal to document a signal variation pattern of the candidate signal corresponding to the voltage drop event.

More specifically, in response to the documented system state SST, the voltage drop analysis circuit 140 may find the circuit signals that are possible to be related to the occurrence of the voltage drop event, such as but not limited to access data related to registers, control signal to control the operation of the circuits, data signals or clock signals generated based on the process or the memory accessing. Moreover, after analyzing the circuit signals, the voltage drop analysis circuit 140 may select one of the circuit signals that is more possible to be related to the occurrence of the voltage drop event to be the candidate signal.

After selecting the candidate signal, the voltage drop analysis circuit 140 may document an intensity variation and a frequency variation of the candidate signal at the time spot of the occurrence of the voltage drop event or a time period before the occurrence of the voltage drop event, a generation of at least one glitch and whether the data carried thereby varies based on the system state SST. These variations are documented as the signal variation pattern.

In an embodiment, the voltage drop analysis circuit 140 may select only one candidate signal to perform analysis and documentation each time. In other embodiments, the voltage drop analysis circuit 140 may select more than one candidate signals to perform analysis and documentation respectively thereon each time.

The voltage drop analysis circuit 140 performs a verification process on the signal variation pattern of the candidate signal and the occurrence of the voltage drop event within a period of operation time of the functional circuit block 110 to generate a prediction reliability PRB of the candidate signal corresponding to the voltage drop event.

In an embodiment, the voltage drop analysis circuit 140 performs the verification process by performing an IR drop analysis on the candidate signal and/or performing comparison on a signal state of the candidate signal when the voltage drop event occurs with historical data of the signal variation pattern. More specifically, during an operation time of the functional circuit block 110, the voltage drop analysis circuit 140 may analyze the candidate signal when the voltage drop event occurs to verify that whether the signal state that the candidate signal has corresponding to the voltage drop event matches the signal variation pattern. In an embodiment, the term “match” means that the signal state of the candidate signal may not be exactly the same as the signal variation pattern and may include a difference within a reasonable range from the signal variation pattern.

In an embodiment, by performing repetitive analysis and documentation, t voltage drop analysis circuit 140 calculates a ratio between a number that the signal state of the candidate signal, which corresponds to the voltage drop event, matches the signal variation pattern within a period of time, and an occurrence number that the voltage drop event occurs within the period of time, in which the ratio is defined as the prediction reliability PRB. When the ratio is larger than a threshold value, the voltage drop analysis circuit 140 determines that the prediction reliability PRB is within the reliable range. In other embodiments, the voltage drop analysis circuit 140 may use other statistics method to configure the prediction reliability PRB and the reliable range to determine whether the statistics result is reliable.

When the prediction reliability PRB is not within the reliable range, the voltage drop analysis circuit 140 may select another circuit signal related to the occurrence of the voltage drop event as the candidate signal, or performs analysis on other circuit signals transmitted by the functional circuit block 110 that are possible to be related to the occurrence of the voltage drop event according to the system state SST so as to select one of the other circuit signals related to the occurrence of the voltage drop event to be the candidate signal.

In an embodiment, the voltage drop analysis circuit 140 described above may only exist during a chip design verification stage and is removed after the candidate signal is selected to reduce the area and the power consumption during the actual operation of the electronic system 100. The present invention is not limited thereto.

When the prediction reliability PRB is within the reliable range, the voltage drop processing circuit 150 may perform the operation described below.

The voltage drop processing circuit 150 set the candidate signal having the prediction reliability PRB within a reliable range to be a target signal TSI so as to receive the target signal TSI directly from the functional circuit block 110 and generate a predicted voltage drop signal PVD according to the target signal TSI having the signal variation pattern to drive the power management circuit 120 to generate the power mode control signal PCS to the functional circuit block 110 to perform a voltage stabilizing process on a target related to the target signal TSI in the functional circuit block 110.

In an embodiment, the voltage drop processing circuit 150 is disposed outside the functional circuit block 110 and receive the target signal TSI from the functional circuit block 110 to perform detection. In an embodiment, the voltage drop processing circuit 150 is integrated to be inside the functional circuit block 110 to directly receive the target signal TSI to perform detection.

In an embodiment, the voltage drop analysis circuit 140 documents the signal variation pattern in a voltage drop history table VDT. The voltage drop history table VDT may be stored in the voltage drop analysis circuit 140 to be accessed by the voltage drop processing circuit 150 or is directly stored by the voltage drop processing circuit 150, as illustrated in FIG. 1. The voltage drop processing circuit 150 compares the signal state of the target signal TSI with the signal variation pattern in the voltage drop history table VDT to generate the predicted voltage drop signal PVD according to the target signal having the signal state that matches the signal variation pattern in the voltage drop history table VDT.

More specifically, when the voltage drop processing circuit 150 determines that the signal state of the target signal TSI matches the signal variation pattern in the voltage drop history table VDT, the voltage drop processing circuit 150 generates the predicted voltage drop signal PVD accordingly and transmits the predicted voltage drop signal PVD to the power management circuit 120. In an embodiment, the term “match” means that the signal state of the target signal TSI may not be exactly the same as the signal variation pattern in the voltage drop history table VDT and may include a difference within a reasonable range from the signal variation pattern.

After receiving the predicted voltage drop signal PVD, the power management circuit 120 generates the power mode control signal PCS to the functional circuit block 110 such that internal power circuit of the functional circuit block 110 operates in different power modes to perform the voltage stabilizing process on the target circuit related to the target signal. In an embodiment, the voltage stabilizing process includes that the functional circuit block 110 prioritizes providing a sufficient voltage to the target circuit.

In a usage scenario, the voltage drop analysis circuit 140 may obtain a signal variation pattern of a specific disturbance waveform of a register in the functional circuit block 110 when being read right before the occurrence of the voltage drop event, such that the read signal of the register is selected from the circuit signals transmitted by the functional circuit block 110 to be the candidate signal so as to document the signal variation pattern thereof.

After the prediction reliability PRB of the read signal of the register corresponding to the voltage drop event is verified to be within the reliable range by using the verification process, the read signal of the register is set to be the target signal TSI. The signal variation pattern, which is the specific disturbance waveform described above, is further documented in the voltage drop history table VDT. The register is configured to be the target circuit related to the target signal TSI.

When a signal state of the read signal of the register happens to be identical or similar to such a specific disturbance waveform, the voltage drop processing circuit 150 determines that the read signal of the register has the signal variation pattern and generates the predicted voltage drop signal PVD such that the power management circuit 120 generates the power mode control signal PCS to the functional circuit block 110 to prioritize to provide a sufficient voltage to the register. Either the occurrence of the voltage drop event can be avoided or the degree of the voltage drop can be reduced.

In the embodiment described above, the condition that a single candidate signal is selected is used. In another embodiment, the voltage drop analysis circuit 140 may select a plurality of candidate signals from the circuit signals transmitted by the functional circuit block 110 after the analysis is performed, and the plurality of candidate signals can be set to be a plurality of target signals under the condition that the prediction reliabilities PRB thereof are determined to be within the reliable range after the verification process is performed. The predicted voltage drop signal can be generated according to one of the plurality of target signals or a combination of the plurality of target signals to drive the power management circuit 120 to perform the voltage stabilizing process on different target circuits. The present invention is not limited thereto.

On the other hand, the condition that a single threshold value is configured for each of the voltage detectors 130A~130C to determine the dropping of the node voltages VNA~VNC is used in the embodiment described above. In another embodiment, more than one threshold values can be configured for any one of the voltage detectors 130A~130C to determine the dropping of the node voltages VNA~VNC.

For example, the voltage detectors 130A~130C generate a slight voltage drop signal (not illustrated in the figure) when any one of the node voltages VNA~VNC drops to a first threshold value to the functional circuit block 110, and generate a severe voltage drop signal (not illustrated in the figure) when any one of the node voltages VNA~VNC drops to a second threshold value, wherein the second threshold value is smaller than the first threshold value.

The voltage drop analysis circuit 140 is configured to document a first signal variation pattern of the candidate signal corresponding to the voltage drop event related to the slight voltage drop signal and document a second signal variation pattern of the candidate signal corresponding to the voltage drop event related to the severe voltage drop signal.

The voltage drop processing circuit 150 is configured to generate a first predicted voltage drop signal according to the target signal TSI having the first signal variation pattern to drive the power management circuit 120 to generate a first power mode control signal to the functional circuit block 110 to perform a first voltage stabilizing process on the target circuit, and is configured to generate a second predicted voltage drop signal according to the target signal TSI having the second signal variation pattern to drive the power management circuit 120 to generate a second power mode control signal to the functional circuit block 110 to perform a second voltage stabilizing process on the target circuit.

In some embodiments, when the predicted voltage drop is a slight voltage drop (i.e., the voltage detectors 130A~130C generate the slight voltage drop signal), the voltage drop processing circuit 150 may not drive the power management circuit 120 to perform voltage-stabilizing and only drive the power management circuit 120 to perform voltage-stabilizing when the predicted voltage drop is a severe voltage drop (i.e., the voltage detectors 130A~130C generate the severe voltage drop signal).

In some embodiments, in order to perform a more accurate determination, the voltage detectors 130A~130C may configure more threshold values to determine the degree of the dropping of the node voltages VNA~VNC. The present invention is not limited thereto.

Besides, in an embodiment, the power management circuit 120 may directly receive the voltage drop signals VDA~VDC from the voltage detectors 130A~130C and generate the power mode control signal PCS accordingly to the functional circuit block 110 so as to perform the voltage stabilizing process when a voltage drop that is not predicted occurs.

The electronic system of the present invention analyzes the system state when the voltage drop event occurs to document a signal variation pattern of a candidate signal so as to set the candidate signal to be a target signal when a prediction reliability associated with the candidate signal is verified to be within a reliable range, such that a predicted voltage drop signal is generated according to the target signal having the signal variation pattern to drive a power management circuit to generate a power mode control signal to perform a voltage stabilizing process on a target circuit that is related to the target signal in a function block to avoid the crash of the circuits due to the voltage drop event.

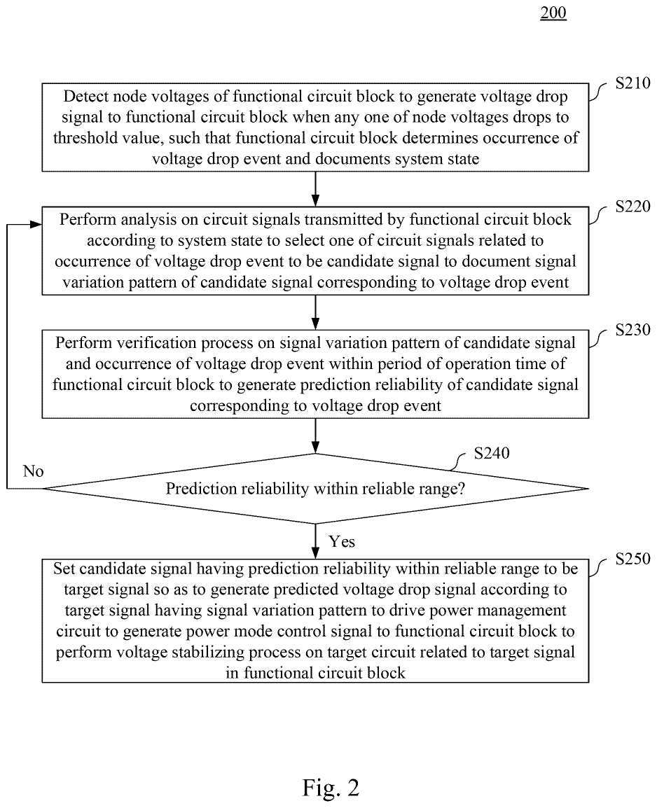

Reference is now made to FIG. 2. FIG. 2 illustrates a flow chart of a voltage drop management method 200 according to an embodiment of the present invention.

In addition to the apparatus described above, the present disclosure further provides the voltage drop management method 200 that can be used in such as, but not limited to, the electronic system 100 in FIG. 1. As illustrated in FIG. 2, an embodiment of the voltage drop management method 200 includes the following steps.

In step S210, the node voltages VNA~VNC of the functional circuit block 110 are detected to generate the voltage drop signal VDA~VDC to the functional circuit block 110 when any one of the node voltages VNA~VNC drops to the threshold value, such that the functional circuit block 110 determines the occurrence of the voltage drop event and documents a system state SST.

In step S220, analysis is performed on the circuit signals transmitted by the functional circuit block 110 according to the system state SST, to select one of the circuit signals related to the occurrence of the voltage drop event to be a candidate signal to document a signal variation pattern of the candidate signal corresponding to the voltage drop event.

As described above, the voltage drop analysis circuit 140 may find the circuit signals that are possible to be related with the occurrence of the voltage drop event and select at least one of the circuit signals that is more possible to be related to the occurrence of the voltage drop event to be the candidate signal.

In step S230, the verification process is performed on the signal variation pattern of the candidate signal and the occurrence of the voltage drop event within the period of the operation time of the functional circuit block 110 to generate the prediction reliability PRB of the candidate signal corresponding to the voltage drop event.

In step S240, whether the prediction reliability PRB is within the reliable range is determined.

When the prediction reliability PRB is not within the reliable range, the flow goes back to step S220 to select another circuit signal related to the occurrence of the voltage drop event from the circuit signals to be the candidate signal, or perform analysis on the other circuit signals transmitted by the functional circuit block 110 that are related to the occurrence of the voltage drop event according to the system state SST and select one of the other circuit signals related to the occurrence of the voltage drop event to be the candidate signal.

In step S250, the candidate signal having the prediction reliability PRB within reliable range is set to be the target signal so as to generate the predicted voltage drop signal PVD according to the target signal TSI having the signal variation pattern to drive the power management circuit 120 to generate the power mode control signal PCS to the functional circuit block 110 to perform the voltage stabilizing process on the target circuit related to the target signal TSI in the functional circuit block 110.

It is appreciated that the embodiments described above are merely an example. In other embodiments, it should be appreciated that many modifications and changes may be made by those of ordinary skill in the art without departing, from the spirit of the disclosure.

In summary, the present invention discloses the electronic system having the voltage drop management mechanism and the voltage drop management method thereof to analyze the system state when the voltage drop event occurs to document a signal variation pattern of a candidate signal so as to set the candidate signal to be a target signal when a prediction reliability associated with the candidate signal is verified to be within a reliable range, such that a predicted voltage drop signal is generated according to the target signal having the signal variation pattern to drive a power management circuit to generate a power mode control signal to perform a voltage stabilizing process on a target circuit that is related to the target signal in a function block to avoid the crash of the circuits due to the voltage drop event.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. An electronic system having a voltage drop management mechanism,
comprising:
a functional circuit block;
a power management circuit;
a plurality of voltage detectors configured to detect a plurality of node voltages of the functional circuit block to generate a voltage drop signal to the functional circuit block when any one of the node voltages drops to a threshold value, such that the functional circuit block determines an occurrence of a voltage drop event and document a system state;
a voltage drop analysis circuit configured to perform analysis on a plurality of circuit signals transmitted by the functional circuit block according to the system state, to select one of the circuit signals related to the occurrence of the voltage drop event to be a candidate signal, document a signal variation pattern of the candidate signal corresponding to the voltage drop event and perform a verification process on the signal variation pattern of the candidate signal and the occurrence of the voltage drop event within a period of operation time of the functional circuit block to generate a prediction reliability of the candidate signal corresponding to the voltage drop event; and
a voltage drop processing circuit configured to set the candidate signal having the prediction reliability within a reliable range to be a target signal so as to generate a predicted voltage drop signal according to the target signal having the signal variation pattern to drive the power management circuit to generate a power mode control signal to the functional circuit block to perform a voltage stabilizing process on a target circuit related to the target signal in the functional circuit block.

2. The electronic system of claim 1, wherein the voltage drop analysis circuit determines that the prediction reliability is not within the reliable range to select another one of the circuit signals related to the occurrence of the voltage drop event as the candidate signal, or perform analysis on a plurality of other circuit signals that the functional circuit block transmits according to the system state to select one of a plurality of other circuit signals related to the occurrence of the voltage drop event as the candidate signal.

3. The electronic system of claim 1, wherein the voltage detectors generate a slight voltage drop signal when any one of the node voltages drops to a first threshold value and generate a severe voltage drop signal when any one of the node voltages drops to a second threshold value, wherein the second threshold value is smaller than the first threshold value;
the voltage drop analysis circuit configured to document a first signal variation pattern of the candidate signal corresponding to the voltage drop event related to the slight voltage drop signal and document a second signal variation pattern of the candidate signal corresponding to the voltage drop event related to the severe voltage drop signal; and
the voltage drop processing circuit is configured to generate a first predicted voltage drop signal according to the target signal having the first signal variation pattern to drive the power management circuit to generate a first power mode control signal to the functional circuit block to perform a first voltage stabilizing process on the target circuit, and is configured to generate a second predicted voltage drop signal according to the target signal having the second signal variation pattern to drive the power management circuit to generate a second power mode control signal to the functional circuit block to perform a second voltage stabilizing process on the target circuit.

4. The electronic system of claim 1, wherein the system state comprises a circuit state and/or a process execution state, the circuit state comprises a register state and/or a hardware signal state and the process execution state comprises a process stack and/or a memory data state.

5. The electronic system of claim 1, wherein the system state corresponds to an occurring time spot of the occurrence of the voltage drop event and/or a time period prior to the occurrence of the voltage drop event.

6. The electronic system of claim 1, wherein the voltage drop analysis circuit documents the signal variation pattern in a voltage drop history table such that the voltage drop processing circuit compares a signal state of the target signal with the signal variation pattern in the voltage drop history table to generate the predicted voltage drop signal according to the target signal having the signal state that matches the signal variation pattern in the voltage drop history table.

7. The electronic system of claim 1, wherein the voltage stabilizing process comprises that the functional circuit block prioritizes providing a sufficient voltage to the target circuit.

8. The electronic system of claim 1, wherein the voltage drop analysis circuit performs the verification process by performing an IR drop analysis on the candidate signal and/or performing comparison on a signal state of the candidate signal when the voltage drop event occurs with historical data of the signal variation pattern.

9. The electronic system of claim 1, wherein the voltage drop processing circuit is configured to set a plurality of candidate signals each having the prediction reliability within the reliable range to be a plurality of target signals to generate the predicted voltage drop signal according to one of or a combination of the target signals having the signal variation pattern.

10. The electronic system of claim 1, wherein the voltage drop analysis circuit calculates a ratio between a number that the signal state of the candidate signal, which corresponds to the voltage drop event, matches the signal variation pattern within a period of time, and an occurrence number that the voltage drop event occurs within the period of time, in which the ratio is defined as the prediction reliability; and
the voltage drop analysis circuit determines that the prediction reliability is within the reliable range when the ratio is larger than a threshold value.

11. A voltage drop management method, comprising:
detecting a plurality of node voltages of a functional circuit block by a plurality of voltage detectors to generate a voltage drop signal to the functional circuit block when any one of the node voltages drops to a threshold value, such that the functional circuit block determines an occurrence of a voltage drop event and document a system state;
performing analysis on a plurality of circuit signals transmitted by the functional circuit block by a voltage drop analysis circuit according to the system state, to select one of the circuit signals related to the occurrence of the voltage drop event to be a candidate signal to document a signal variation pattern of the candidate signal corresponding to the voltage drop event;
performing a verification process on the signal variation pattern of the candidate signal and the occurrence of the voltage drop event within a period of operation time of the functional circuit block by the voltage drop analysis circuit to generate a prediction reliability of the candidate signal corresponding to the voltage drop event; and
setting the candidate signal having the prediction reliability within a reliable range to be a target signal by a voltage drop processing circuit so as to generate a predicted voltage drop signal according to the target signal having the signal variation pattern to drive a power management circuit to generate a power mode control signal to the functional circuit block to perform a voltage stabilizing process on a target circuit related to the target signal in the functional circuit block.

12. The voltage drop management method of claim 11, further comprising:
determining that the prediction reliability is not within the reliable range by the voltage drop analysis circuit to select another one of the circuit signals related to the occurrence of the voltage drop event as the candidate signal, or perform analysis on a plurality of other circuit signals that the functional circuit block transmits according to the system state to select one of a plurality of other circuit signals related to the occurrence of the voltage drop event as the candidate signal.

13. The voltage drop management method of claim 11, further comprising:
generating a slight voltage drop signal by the voltage detectors when any one of the node voltages drops to a first threshold value and generating a severe voltage drop signal by the voltage detectors when any one of the node voltages drops to a second threshold value, wherein the second threshold value is smaller than the first threshold value;
documenting a first signal variation pattern of the candidate signal corresponding to the voltage drop event related to the slight voltage drop signal and documenting a second signal variation pattern of the candidate signal corresponding to the voltage drop event related to the severe voltage drop signal by the voltage drop analysis circuit; and
generating a first predicted voltage drop signal according to the target signal having the first signal variation pattern by the voltage drop processing circuit to drive the power management circuit to generate a first power mode control signal to the functional circuit block to perform a first voltage stabilizing process on the target circuit, and generating a second predicted voltage drop signal according to the target signal having the second signal variation pattern by the voltage drop processing circuit to drive the power management circuit to generate a second power mode control signal to the functional circuit block to perform a second voltage stabilizing process on the target circuit.

14. The voltage drop management method of claim 11, wherein the system state comprises a circuit state and/or a process execution state, the circuit state comprising a register state and/or a hardware signal state and the process execution state comprising a process stack and/or a memory data state.

15. The voltage drop management method of claim 11, wherein the system state corresponds to an occurring time spot of the occurrence of the voltage drop event and/or a time period prior to the occurrence of the voltage drop event.

16. The voltage drop management method of claim 11, further comprising:
documenting the signal variation pattern in a voltage drop history table by the voltage drop analysis circuit such that the voltage drop processing circuit compares a signal state of the target signal with the signal variation pattern in the voltage drop history table to generate the predicted voltage drop signal according to the target signal having the signal state that matches the signal variation pattern in the voltage drop history table.

17. The voltage drop management method of claim 11, wherein the voltage stabilizing process comprises that the functional circuit block prioritizes providing a sufficient voltage to the target circuit.

18. The voltage drop management method of claim 11, further comprising:
performing the verification process by the voltage drop analysis circuit by performing an IR drop analysis on the candidate signal and/or performing comparison on a signal state of the candidate signal when the voltage drop event occurs with historical data of the signal variation pattern.

19. The voltage drop management method of claim 11, further comprising:
setting a plurality of candidate signals each having the prediction reliability within the reliable range to be a plurality of target signals by the voltage drop processing circuit to generate the predicted voltage drop signal according to one of or a combination of the target signals having the signal variation pattern.

20. The voltage drop management method of claim 11, further comprising:
calculating a ratio between a number that the signal state of the candidate signal, which corresponds to the voltage drop event, matches the signal variation pattern within a period of time, and an occurrence number that the voltage drop event occurs within the period of time by the voltage drop analysis circuit, in which the ratio is defined as the prediction reliability; and
determining that the prediction reliability is within the reliable range when the ratio is larger than a threshold value by the voltage drop analysis circuit.
